(19) United States
(12) Patent Application Publication
(10) Pub. No.: US 2021/0404503 A1
(43) Pub. Date: Dec. 30, 2021

(54) Collar Nut

(71) Applicant: Tom Borst, Clayton, CA (US)

(72) Inventor: Tom Borst, Clayton, CA (US)

(21) Appl. No.: 17/354,727

(22) Filed: Jun. 22, 2021

Related U.S. Application Data
(60) Provisional application No. 63/044,189, filed on Jun. 25, 2020.

(51) Int. Cl. F16B 33/02; E04H 12/22

(52) U.S. Cl. CPC F16B 33/02; E04H 12/2253

(57) ABSTRACT

A uniquely configured, hardened collar nut for use in the installation and retrofitting of light poles, and method of using same.

### CROSS-REFERENCE TO RELATED APPLICATIONS

This is a Non-Provisional application claiming the benefit of co-pending Provisional Application No. 63/044,189 filed Jun. 25, 2020.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to the field of wireless communication systems. More particularly, the invention concerns the installation and retrofitting of light poles suitable for use in housing cellular gear for mobile phone and broadband services.

### Discussion of the Prior Art

The substantial increase in the amount of data being conveyed over the wireless communication system during recent years has made it necessary to significantly increase the network footprint throughout cities across the nation. Accordingly, telecommunication companies are looking to utilize all possible avenues for use in housing cellular gear, including the use of existing light poles. However, many poles have been found to be outdated and requiring modification. Consequently, the carriers have been forced to bring light poles up to current codes and have been required to secure permits to modify the light poles. Carriers have not only been required to secure permits, but also have been forced to become involved in weeks of scheduling, undergoing special inspections, and arrangement for lane closures and traffic control at each light pole that is to be modified.

With the foregoing in mind, a primary object of the present invention is to provide a method and apparatus for significantly simplifying the modification of existing light poles and in so doing, eliminating the replacement of expensive concrete foundations, the replacement of anchor bolts, and the avoidance of lane closures thereby substantially lowering carrier costs.

### SUMMARY OF THE INVENTION

By way of brief summary, one form of the present invention concerns a uniquely configured, hardened collar nut for use in the installation and retrofitting of light poles. Another form of the present invention concerns a novel method for retrofitting existing light poles by replacing the existing nuts with the hardened collar nuts of the invention.

With the forgoing in mind, it is an object of the present invention to provide a signature hardened steel and tapered collar nut that is receivable within the apertures of the baseplates of conventional light poles.

Another very important object of the invention is to provide a collar nut of the character described in the preceding paragraph that is constructed from AISI 4130 high strength light weight aircraft alloy steel containing a strengthening agent.

Still another important object of the invention is to provide a collar nut of the character described that is constructed from steel having a Rockwell hardness of between about 30 RC and about 45 RC.

Another object of the invention is to provide a collar nut that during the retrofit of a prior art pole, the collar nut skirt is strong enough to move the soft baseplate and the light pole and to self-correct the threaded rod J-Bolts of the light pole.

Yet another object of the invention is to provide a signature hardened steel and tapered collar nut that when properly installed within a conventional prior art light pole will place the light pole and compliance with local codes.

These and other objects of the invention will become apparent from the description of the invention that follows.

### BRIEF DESCRIPTION OF THE DRAWINGS

FIG. 1 is a generally perspective view of one form of prior art light pole construction.

FIG. 2 is a greatly enlarged, generally perspective view taken along lines 2-2 of FIG. 1.

FIG. 3 is a generally perspective view of one form of the collar nut of the invention.

FIG. 4 is a side elevational view of one form of the collar nut of the invention.

FIG. 5 is a cross-sectional view taken along lines 5-5 of FIG. 4.

FIG. 6 is a front view showing one form of the collar nut of the invention connected to an anchor bolt and extending into a conventional pole base.

FIG. 7 is a cross-sectional view taken along lines 7-7 of FIG. 6.

FIG. 8 is a top view of four prior art nuts connected to four anchor bolts extending through a prior art pole base.

### DESCRIPTION OF THE INVENTION

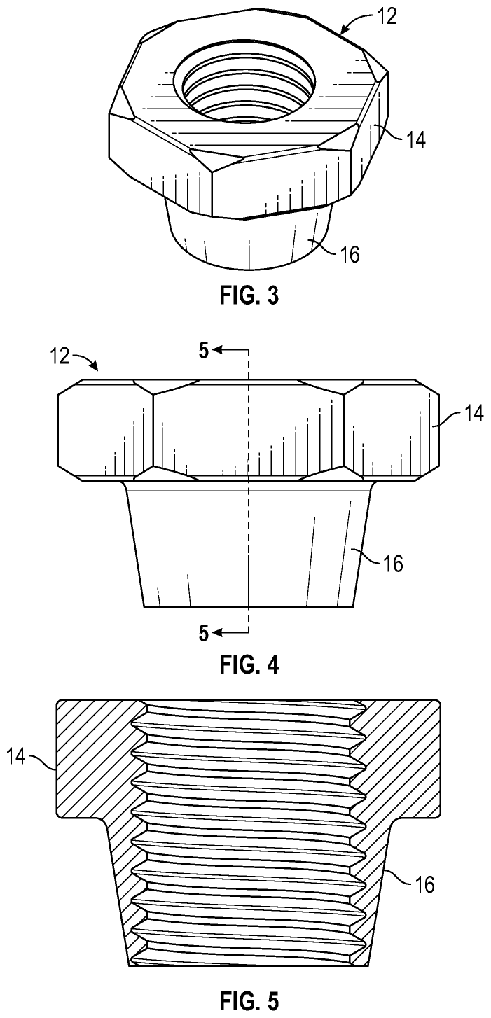

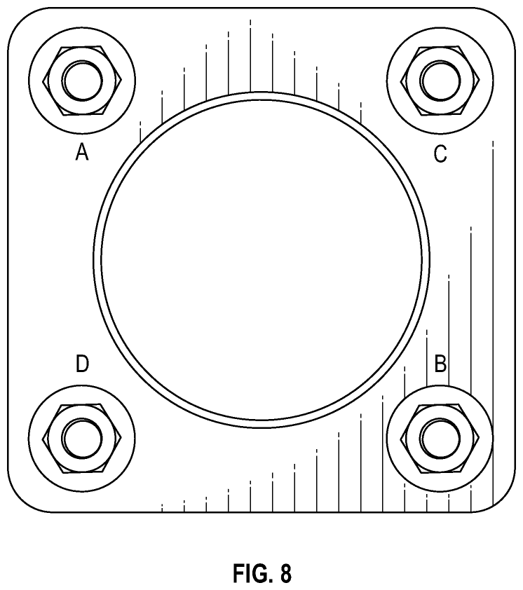

Referring to the drawings and particularly to FIGS. 3, 4, and 5, one form of the novel collar nut of the invention is there shown and generally designated by the numeral 12. Nut 12 includes a hex shaped head 14 and an internally threaded tapered skirt 16 that is connected to and extends outwardly from head 14. Nut 12 is preferably constructed from AISI 4130 high strength light weight aircraft alloy steel containing molybdenum and chromium as strengthening agents. However, a variety of other steels, the character of which will be described hereinafter, can be used to construct the nut. Whichever steel is selected, it is critical that the steel be properly heat-treated. For 4130 steel, an acceptable heat treatment consists of heating to austenitizing temperature, typically 1600° F. (870° C.), followed by water quenching. More particularly, the nut must be treated to a Rockwell hardness of between a minimum of about 30 RC and a maximum of about 45 RC. As will be discussed in greater detail hereinafter, in use, with the tapered skirt of the nut resting inside the holes of baseplate (see FIG. 7), the hardened nut is strong enough to move the soft baseplates of the prior art poles in a manner to fasten itself and to self-correct the threaded rod J-Bolts. Depending upon the use that is to be made of the collar nut, the steel collar can be plated with a number of materials including nickel and chromium.

In order to ensure that the hardened steel collar nuts 12 of the invention retain their strength without cracking during use, it is desirable that hydrogen embrittlement relief be performed. Hydrogen embrittlement is a metal's loss of ductility and reduction of load bearing capability due to the absorption of hydrogen atoms or molecules by the metal. The result of hydrogen embrittlement is that components crack and fracture at stresses less than the yield strength of the metal. It is well understood by those skilled in the art that hydrogen embrittlement relief can be satisfactorily performed in an industrial oven at a specified temperature in order to bake the hydrogen out of the metal.

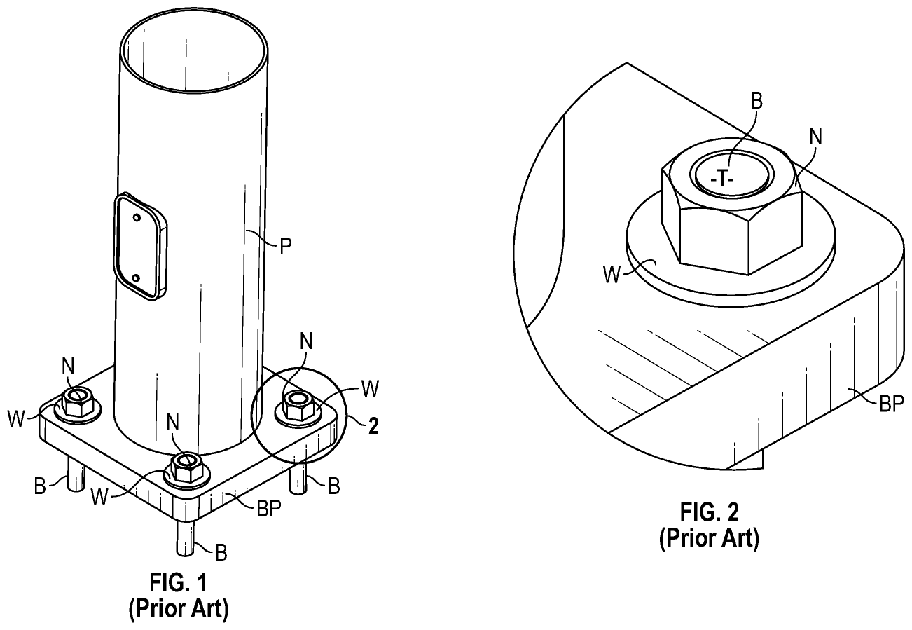

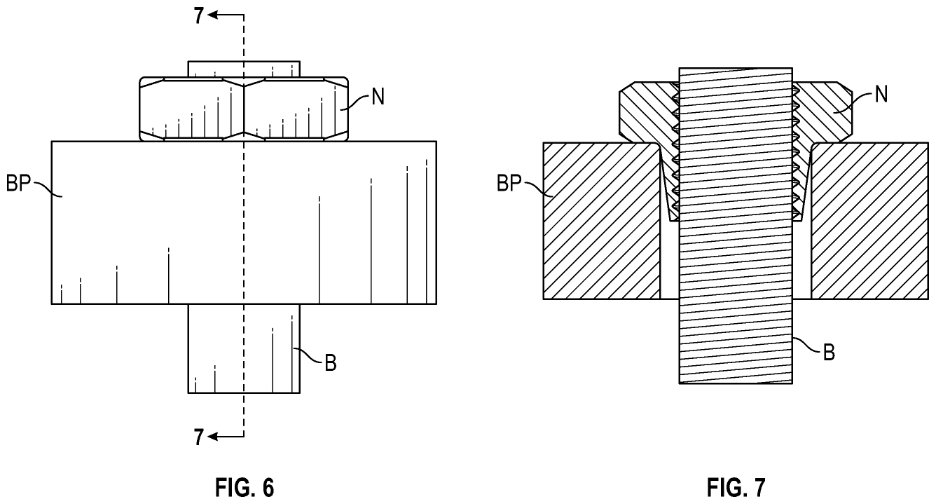

As previously discussed, the hardened steel collar nuts of the invention are often used in retrofitting of existing light poles. In this regard, when an existing light pole is to be used to house the carrier's cellular gear, the light pole must be modified to comply with local codes. Referring to FIGS. 1 and 2 of the drawings, a typical prior art light pole construction is there illustrated. Typically, the prior art light pole comprises a concrete foundation within which four anchor bolts “B” are embedded. The anchor bolts extend through spaced apart openings provided in a pole baseplate “BP” to which the light pole “P” is connected. Threadably connected to the anchor bolts are hex nuts “N”. Disposed between the hex nuts and the pole base are conventional washers “W”. As illustrated in FIG. 2, often the tops “T” of the anchor bolts are flush, or nearly flush, with the upper surface of the nuts “N”. In many instances, this construction does not comply with local codes. By way of example, in the state of California, the California Standard Specifications requires that in light pole construction within the state “anchor bolts shall extend a minimum of three full threads above the top of the nut”. Similarly, the Industrial Fasteners Institute specifies that in construction such as light pole construction, a minimum of two thread pitches should extend beyond the top surface of the nut. When prior art light pole constrictions such as those illustrated in FIGS. 1 and 2 of the drawings are encountered, the carrier will be required to secure permits to modify the light pole and will often be forced to undertake costly modifications, such as removal and replacement of the concrete foundation, removal and replacement of the anchor bolts and repositioning of the light pole. The thrust of one form of the method of the present invention is directed to the solution of these costly and time-consuming problems. A key aspect of this method is the replacement of the hex nuts of the prior art light poles with the novel hardened steel collar nuts of the present invention. In the preferred method of the invention for retrofitting a prior art light pole of the character shown in FIGS. 1 and 2 of the drawings, the existing light pole nuts are sequentially removed. More particularly as shown in FIGS. 6, 7, and 8, the first step of the retrofit method is to remove nut A (FIG. 8) and replace it with a collar nut 12 in the manner shown in FIG. 7. As shown in the drawings, as the nut is threaded onto the existing anchor bolt “B”, the tapered skirt 16 of the collar nut will move into the hole in the baseplate “BP” that is adjacent the anchor bolt. The second step of the method comprises a repeat of step one with the removal of nut B and its replacement with a collar nut 12. The third and fourth steps of the method also comprises a repeat of step one with the removal of nut C and its replacement with a collar nut 12 and the removal of nut D and its replacement with a collar nut 12. This done, the collar nuts are sequentially tightened (A, B, C, and D) into the position shown in FIG. 7. As the nuts are tightened, the hardened steel skirts of the nuts are strong enough to move the soft baseplate and the pole and correct the location of the anchor bolts. In the final step of the retrofit method of the invention, the collar nuts are sequentially tightened until a minimum of three threads of each of the anchor bolts “B” extends above the top surface of each of the nuts 12 thereby meeting the local code requirements.

When available and suitable for the retrofit to be accomplished, the following steels materials may be considered for use.

| Standard | Grade | C | Mn | P | S | Si | Cr | M | Ni |
|---|---|---|---|---|---|---|---|---|---|
| ASTM A29 | 4340 | 0.38-0.43 | 0.60-0.80 | 0.035 | 0.040 | 0.15-0.35 | 0.70-0.90 | 0.20-0.30 | 1.65-2.00 |
| AISI 4130 | 4130 | 0.28-0.33 | 0.40-0.60 | 0.035 | 0.040 | 0.15-0.35 | 0.80-1.10 | 0.15-0.25 | |

ASTM A194 Carbon and alloy steel nuts for bolts for high pressure and high temperature service.

The ASTM A194 specification covers carbon, alloy and stainless steel nuts intended for use in high-pressure and/or high-temperature service. Unless otherwise specified, the American National Standard Heavy Hex Series (ANSI B 18.2. 2) shall be used.

ASTM A563 Standard specification for carbon and alloy steel nuts.

The ASTM A563 specification covers carbon and alloy steel nuts for general structural and mechanical uses on bolts, studs, and other externally threaded parts. DH nuts are made of medium carbon steel and heat treated. They are recommended for F3125 A490 structural bolts and in many other applications.

AISI 4130 High strength lightweight Aircraft alloy steel containing molybdenum and chromium as strengthening agents.

The carbon content is nominally 0.30% and with this relatively low carbon content the alloy is excellent from the fusion weldability standpoint. The alloy can be hardened by heat treatment.

ASTM 4140 High strength light weight Aircraft alloy steel containing chromium, molybdenum, and manganese.

It is widely used across numerous industries and is an excellent material choice due to its toughness, high fatigue strength, and abrasion and impact resistance.

AISI 4340 is a heat treatable, low alloy steel containing nickel, chromium and molybdenum. It is known for its toughness and capability of developing high strength in the heat treated condition while retaining good fatigue strength.

The ASTM A194 specification covers carbon, alloy and stainless steel nuts intended for use in high-pressure and/or high-temperature service. Unless otherwise specified, the American National Standard Heavy Hex Series (ANSI B 18.2.2) shall be used. Nuts up to and including 1 inch nominal size shall be UNC Series Class 2B fit. Nuts over 1 inch nominal size shall be either UNC Series Class 2B fit or 8 UN Series Class 2B fit. High strength ASTM A194 grade 2H nuts are common in the marketplace and are often substituted.

### A194 Chemical Property Specifications

| | | | 7M |
|---|---|---|---|
| Element | 2, 2H, and 2HM | 4 7 | (AISI 4140) |
| Carbon | 0.40% min | 0.40-0.50% | 0.37-0.49% |
| Manganese | 1.00% max | 0.70-0.90% | 0.65-1.10% |
| Phosphorus, max | 0.040% | 0.035% 0.035% | 0.045% |
| Sulfur, max | 0.050% 0.040% | 0.040% 0.030% | 0.030% |
| Silicon | 0.40% max | 0.15-0.35% | 0.15-0.35% |
| Chromium | 0.75-1.20% | | |
| Nickel | | | |
| Molybdenum | | 0.20-0.30% | 0.15-0.25% |

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A collar nut comprising a head and an internally threaded skirt connected to and extending from said head.

2. The collar nut as defined in claim 1 in which said threaded skirt is constructed from hardened steel.

3. The collar nut as defined in claim 1 that is constructed from AISI 4130 high strength lightweight aircraft alloy steel containing a strengthening agent.

4. The collar nut as defined in claim 1 that is constructed from steel having a Rockwell hardness of between about 30 RC and about 45 RC.

5. The collar nut as defined in claim 1 that is nickel plated.

6. A hardened steel collar nut comprising a head and an internally threaded skirt connected to and extending from said head, said threaded skirt being constructed from AISI 4130 high strength lightweight aircraft alloy steel containing a strengthening agent.

7. The collar nut as defined in claim 6 that is constructed from steel having a Rockwell hardness of between about 30 RC and about 45 RC.

8. The collar nut as defined in claim 6 that is nickel plated.

9. A method of retrofitting a light pole of the character having a base plate having an aperture, a threaded anchor bolt extending through the aperture, and a threaded nut connected to the anchor bolt, said method comprising the steps of removing the threaded nut from the anchor bolts and replacing it with a collar nut having a head and an internally threaded skirt extending from said head.

10. The method as defined in claim 9 in which said anchor bolts include a plurality of spaced apart threads and in which said method includes the step of tightening said collar nut until a minimum of 3½ threads extend from said collar nut.

11. A method of retrofitting a light pole of the character having a base plate having a plurality of spaced apart apertures, a bolt extending through each of said apertures and a threaded nut connected to each of said anchor bolts, said method comprising the steps of:
(a) removing one of said threaded nuts from a selected one of said anchor bolts and replacing it with a collar nut having a threaded skirt;
(b) removing another of said threaded nuts from a another of said anchor bolts and replacing it with a collar nut having a threaded skirt;
(c) removing still another of said threaded nuts from still another of said anchor bolts and replacing it with a collar nut having a threaded skirt; and
(d) removing yet another of said threaded nuts from yet another of said anchor bolts and replacing it with a collar nut having a threaded skirt.

12. A method of retrofitting a light pole of the character having a base plate having four spaced apart apertures, four anchor bolts extending through the apertures and four threaded nuts connected to the anchor bolts, said method comprising the steps of:
(a) removing one of the four threaded nuts from a selected one of the anchor bolts and replacing it with a collar nut having a threaded skirt;
(b) removing another of the four threaded nuts from a another of the anchor bolts and replacing it with a collar nut having a threaded skirt;
(c) removing still another of the four threaded nuts from still another of the anchor bolts and replacing it with a collar nut having a threaded skirt; and
(d) removing yet another of the four threaded nuts from yet another of the anchor bolts and replacing it with a collar nut having a threaded skirt.
